(19) United States
(12) Patent Application Publication
(10) Pub. No.: US 2015/0033851 A1
(43) Pub. Date: Feb. 5, 2015

(54) APPARATUS FOR DRIVING GYRO SENSOR AND METHOD FOR CONTROLLONG THEREOF

(71) Applicant: SAMSUNG ELECTRO-MECHANICS CO., LTD., Suwon-si (KR)

(72) Inventors: Byoung Won HWANG, Suwon-si (KR); Kyung Rin Kim, Suwon-si (KR); Chang Hyun Kim, Suwon-si (KR)

(73) Assignee: SAMSUNG ELECTRO-MECHANICS CO., LTD., Suwon-si (KR)

(21) Appl. No.: 14/203,192

(22) Filed: Mar. 10, 2014

(30) Foreign Application Priority Data
Aug. 2, 2013 (KR) 10-2013-0091993

(51) Int. Cl. G01C 19/56

(52) U.S. Cl. CPC G01C 19/56
USPC 73/504.12

(57) ABSTRACT

Disclosed herein is an apparatus for driving a gyro sensor, the apparatus including: a driving unit, an automatic gain control unit, and a first signal converting unit, wherein the driving unit transmits data for a phase value or amplitude value so that an operation of a control gain for an amplitude or phase of a driving mass resonance of the automatic gain control unit may be performed depending on a preset ratio.

### CROSS REFERENCE TO RELATED APPLICATION

This application claims the benefit of Korean Patent Application No. 10-2013-0091993, filed on Aug. 2, 2013, entitled “Apparatus for Driving Gyro Sensor and Method for Controlling Thereof”, which is hereby incorporated by reference in its entirety into this application.

### BACKGROUND OF THE INVENTION

1. Technical Field

The present invention relates to an apparatus for driving a gyro sensor and a method for controlling thereof.

2. Description of the Related Art

Mobile devices, which have been recently developed, having a gyro sensor (an accelerator sensor, a gyro sensor, a geomagnetic sensor, or the like) mounted therein using inertial input applied from the outside have been generally released. Among various gyro sensors described above, the gyro sensor is a sensor capable of detecting an amount of rotating force applied to an object to measure a correspond angular velocity. The angular velocity may be obtained by Coriolis' force “F=2 mΩV”, where m represents a mass of a sensor mass, Ω represents an angular velocity to be measured, and V represents a motion velocity of the sensor mass.

FIG. 1 illustrates a principle of detecting the angular velocity of the gyro sensor. When the mass of the sensor resonates in an X direction and the rotating force is applied in a Z direction, the Coriolis' force is generated in a Y direction to convert the corresponding signal into an electrical signal and the converted signal detects inertial force for the angular velocity by a predetermined signal processing process by a control circuit of the gyro sensor. Therefore, in order to detect stable inertial input, it is important to always stably perform the resonance of the mass of the gyro sensor.

In addition, in order to stably perform the resonance of the mass of the gyro sensor, a mass resonance amplitude control and a phase control are most important, where the mass resonance amplitude control is performed so that the mass may always resonate at a constant amplitude and the phase control is performed so that a phase difference at which the mass resonates against a signal generated from the control circuit to perform the resonance of the mass may be always constantly maintained.

Therefore, in general, because a phase or amplitude control scheme of the mass resonance of the gyro sensor according to the prior art such as in Patent Document described in the following prior art document has manually set a control value or used an analog circuit (e.g., a phase locked loop or a feedback loop), a variation in the mass caused by modification of an MEMS structure body after an initial set may not be corrected by a real-time monitoring and a consumed current, and the like may be increased due to a relative increase in a circuit size in terms of the control scheme using the analog circuit.

### PRIOR ART DOCUMENT

### Patent Document

(Patent Document 1) JP2004212111

### SUMMARY OF THE INVENTION

The present invention has been made in an effort to provide an apparatus for driving a gyro sensor capable of decreasing a size of an entire circuit and a consumed current and performing a control having high degree of precision by differentially controlling a phase and an amplitude of driving mass resonance by a digital automatic gain control unit of a digital scheme to perform a stable control of the phase and the amplitude for the driving mass resonance of the gyro sensor, and a method for controlling thereof.

According to a preferred embodiment of the present invention, there is provided an apparatus for driving a gyro sensor, the apparatus including: a driving unit detecting an amplitude value and a phase value of a driving mass resonance from a driving displacement signal of a gyro sensor and transmitting data for the phase value or amplitude value; an automatic gain control unit differentially performing an operation of a control gain for an amplitude or phase of the driving mass resonance depending on a preset ratio so that after converting the phase value or amplitude value transmitted from the driving unit into a digital value, the digital value converges on a preset target value; and a first signal converting unit converting the control gain into an analog value and transmitting the analog value to the driving unit, wherein the driving unit transmits data for the phase value or amplitude value so that the operation of the control gain for the amplitude or phase of the driving mass resonance of the automatic gain control unit is performed depending on the preset ratio.

The automatic gain control unit may allow the operation of the control gain for the phase and the amplitude of the driving mass resonance to be differentially performed depending on a ratio of N to 1=phase to amplitude (N≧1).

The automatic gain control unit may apply a pre-operated control gain for the amplitude or phase of the driving mass resonance to the driving unit so that the amplitude value or phase value of the driving mass resonance approaches the target value, at the time of an initial driving of the driving mass.

The first signal converting unit may be a digital to analog (D/A) converter.

The driving unit may include: a driving circuit module generating a driving signal having the control gain for the phase or amplitude of the driving mass resonance reflected thereto to thereby apply the driving signal to the gyro sensor and receiving a driving displacement signal from the gyro sensor to thereby detect the phase value and the amplitude value of the driving mass resonance; and a data transmitting module transmitting data for the phase value or amplitude value so that the operation of the control gain for the amplitude or phase of the driving mass resonance in the automatic gain control unit is differentially performed depending on the preset ratio.

The driving circuit module may mix the driving displacement signal with a signal having a phase retarded by 90° compared to the driving signal to thereby detect the amplitude value of the driving mass resonance; and mix the driving displacement signal with a signal having the same phase as the driving signal to thereby detect the phase value of the driving mass resonance.

The data transmitting module may be an analog mux.

The automatic gain control unit may include: a digital converting module converting the amplitude value or phase value of the driving mass resonance input from the driving unit into a digital value; and a gain control module differentially performing the operation of the control gain for the amplitude and the phase of the driving mass resonance depending to a ratio of N to 1 (N≧1) so that the digital value converges on the preset target value.

The automatic gain control unit may include a memory storing the pre-operated control gain for the amplitude or phase of the driving mass resonance so that the amplitude value or phase value of the driving mass resonance approaches the target value at the time of an initial driving of the driving mass.

According to another preferred embodiment of the present invention, there is provided a method for controlling an apparatus for driving a gyro sensor, the method including: detecting, by a driving unit, an amplitude value and a phase value of a driving mass resonance from a driving displacement signal of a gyro sensor; transmitting, by the driving unit, data of the amplitude value or phase value of the driving mass resonance; differentially performing, by an automatic gain control unit, an operation of a control gain for an amplitude or phase of the driving mass resonance depending on a preset ratio so that after converting data for the amplitude value or phase value into a digital value, the digital value converges on a preset target value; and converting, by a first signal converting unit, the control gain into an analog value and transmitting the analog value to the driving unit.

The method may further include, before the detecting of the amplitude value and the phase value of the driving mass resonance, receiving, by the driving unit, the pre-operated control gain for the amplitude or phase of the driving mass resonance from the automatic gain control unit so that the amplitude value or phase value of the driving mass resonance stored in a memory approaches the target value at the time of an initial driving of a driving mass; and applying a driving signal having the control gain reflected thereto to the gyro sensor.

The detecting of the amplitude value and the phase value of the driving mass resonance may include: applying a driving signal having the control gain reflected thereto to the gyro sensor and receiving the driving displacement signal from the gyro sensor; mixing the driving displacement signal with a signal having a phase retarded by 90° compared to the driving signal to thereby detect the amplitude value of the driving mass resonance; and mixing the driving displacement signal with a signal having the same phase as the driving signal to thereby detect the phase value of the driving mass resonance.

The transmitting of the data of the amplitude value or phase value of the driving mass resonance may include: transmitting, by the automatic gain control unit, a data transmitting signal to the driving unit so that the operation of the control gain for the phase and the amplitude of the driving mass resonance is differentially performed depending on a ratio of N to 1; and transmitting, by the driving unit, data for the phase value or amplitude value of the driving mass resonance depending on the data transmitting signal.

The differentially performing, by the automatic gain control unit, of the operation of the control gain for the amplitude or phase of the driving mass resonance depending on the preset ratio may include: converting, by a digital converting module, the amplitude value or phase value of the driving mass resonance input from the driving unit into a digital value; and differentially performing, a gain control module, the operation of the control gain for the phase and the amplitude of the driving mass resonance depending on a ratio of N to 1 (N≧1) so that the digital value converges on the preset target value.

The digital converting module may be an analog to digital (A/D) converter.

The first signal converting unit may be a digital to analog (D/A) converter.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a principle of detecting an angular velocity of a gyro sensor;

FIG. 2 is a block diagram showing a driving apparatus of a gyro sensor according to a preferred embodiment of the present invention;

FIG. 3 is a diagram showing an entire system for the driving apparatus of the gyro sensor according to the preferred embodiment of the present invention;

FIGS. 4A and 4B are diagrams for describing processes detecting phase and amplitude values of driving mass resonance from a driving circuit module according to a preferred embodiment of the present invention;

FIGS. 5A and 5B are diagrams showing data processing processes in an automatic gain control unit according to a preferred embodiment of the present invention; and

FIG. 6 is a flowchart showing a method for controlling the driving apparatus of the gyro sensor according to a preferred embodiment of the present invention.

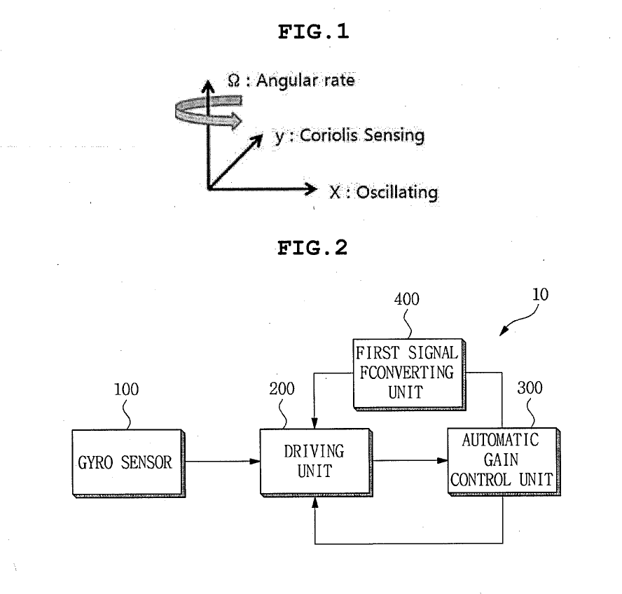

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

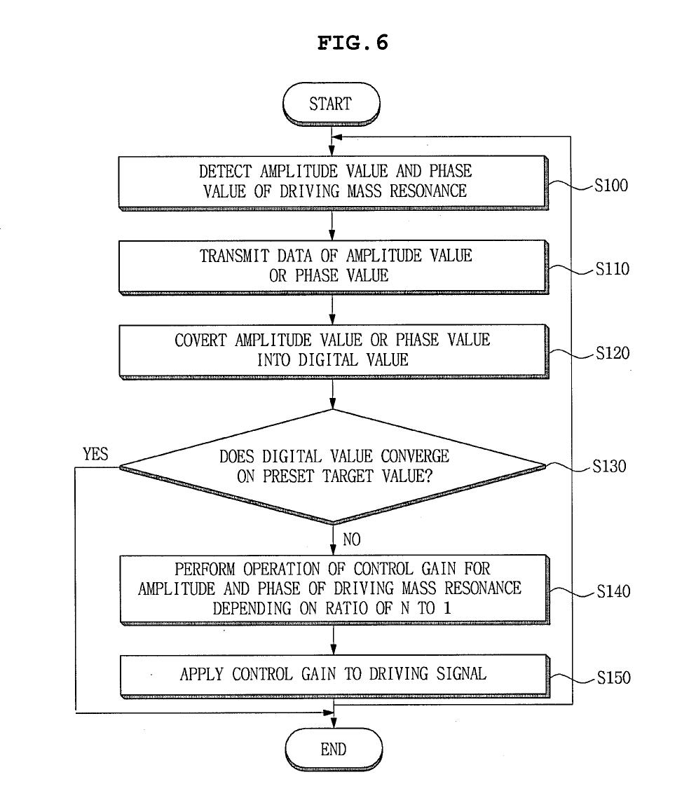

FIG. 2 is a block diagram showing a driving apparatus of a gyro sensor according to a preferred embodiment of the present invention and FIG. 6 is a flowchart showing a method for controlling the driving apparatus of the gyro sensor according to a preferred embodiment of the present invention.

As shown in FIG. 2, the driving apparatus of the gyro sensor according to the preferred embodiment of the present invention is configured to include a gyro sensor 100, a driving unit 200, an automatic gain control unit 300, and a first signal converting unit 400.

The gyro sensor 100 is a sensor including a driving mass (not shown) to detect angular velocities in three axial directions positioned in a space, a driving signal (a pulse wave) applied from the driving unit 200 vibrates the driving mass (not shown), and a driving displacement signal (a sine wave) is generated by the vibration.

Here, a condition in which the driving mass (not shown) resonates by the driving signal is that a phase difference between the driving signal and the driving displacement signal needs to be 90°. In the case in which the driving mass resonates, although the driving signal has a small amplitude, a large motion occurs at the driving mass (not shown), thereby making it possible to obtain the driving displacement signal having a large amplitude. Therefore, in order to obtain a large output from the gyro sensor, it is important to always stably resonate the driving mass.

The driving unit 200 detects an amplitude value and a phase value of a driving mass resonance, from the driving displacement signal output from the gyro sensor 100 (S100), transmit data for the phase value or amplitude value to the automatic gain control unit 300 (S110), and includes a driving circuit module 210 and a data transmitting module 220. A detail description thereof will be described below.

The automatic gain control unit 300 converts the phase value or amplitude value transmitted from the driving unit 200 into a digital value (S120), determines whether or not the digital value converges on a preset target value (S130), then differentially performs an operation of a control gain for an amplitude or phase of the driving mass resonance depending on a preset ratio so that the digital value converge on the preset target value (S140), and includes a digital converting module 310 and a gain control module 320.

Here, the automatic gain control unit 300 differentially performs a control for the phase and the amplitude of the driving mass resonance so that the operation of the control gain for the phase and the amplitude of the driving mass resonance may be performed depending on a ratio of N to 1=phase to amplitude (N≧1).

In addition, the automatic gain control unit 300 may transmit the pre-operated control gain for the amplitude or phase of the driving mass resonance to the driving unit 200 at the time of the initial driving of the driving mass so that the amplitude value or phase value of the driving mass resonance may approach the target value, and the driving unit 200 may apply the control gain to the driving mass and drive the driving mass.

The first signal converting unit 400 converts a control gain for the amplitude or phase of the driving mass resonance operated into the digital value by the automatic gain control unit 300 into an analog value and transmits the analog value to the driving unit 200, where the first signal converting unit 400 may be a digital to analog (D/A) converter.

As described above, according to the preferred embodiment of the present invention, a size of the entire control circuit and a consumed current may be decreased and a degree of precision of the control may be increased compared to an analog scheme by controlling the phase and the amplitude of the driving mass resonance for the gyro sensor in a digital signal processing scheme using the automatic gain control unit 300 and the A/D converter.

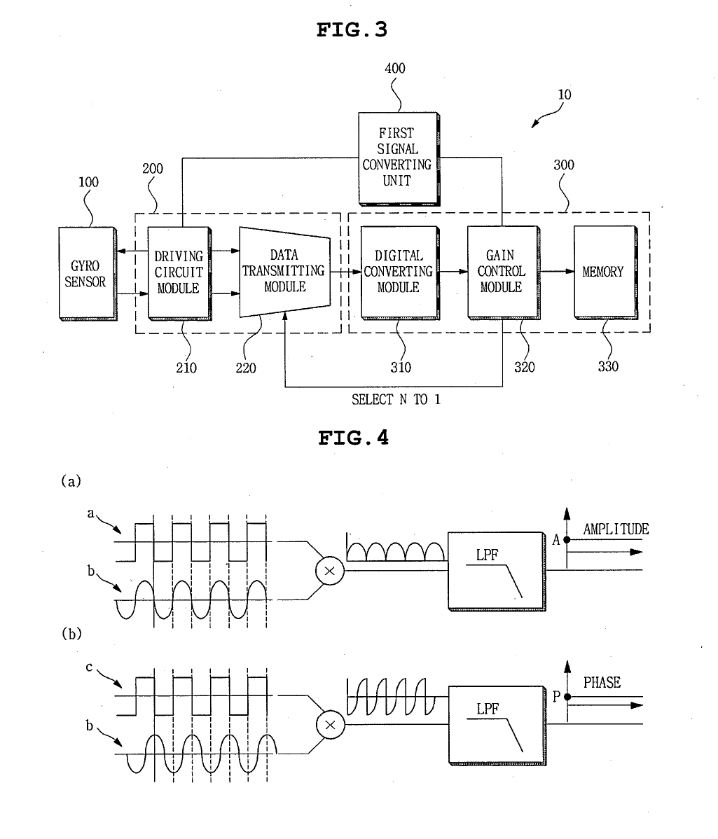

Hereinafter, a driving scheme of the driving unit 200 according to a preferred embodiment of the present invention will be described in detail with reference to FIGS. 3 to 4B.

FIG. 3 is a diagram showing an entire system for the driving apparatus of the gyro sensor according to the preferred embodiment of the present invention and FIGS. 4A and 4B are diagrams for describing processes detecting phase and amplitude values of driving mass resonance from a driving circuit module according to a preferred embodiment of the present invention.

As shown in FIG. 3, the driving unit 200 includes the driving circuit module 210 and the data transmitting module 220, and detects the amplitude value and the phase value of the driving mass resonance from the driving displacement signal output from the gyro sensor 100.

The driving circuit module 210 generates a driving signal having the control gain for the phase or amplitude of the driving mass resonance reflected thereto to thereby apply the driving signal to the gyro sensor 100, and receives the driving displacement signal from the gyro sensor to thereby detect the phase value and the amplitude value of the driving mass resonance.

That is, as shown in FIG. 4A, in the case in which the driving displacement signal b and a signal a having a phase retarded by 90° compared to the driving signal are mixed by a mixer and are then filtered by a low pass filter (LPF), the amplitude value of the driving mass resonance converted into a predetermined voltage level A of a direct current (DC) form in which high frequency components are removed may be obtained. Here, the automatic gain control unit 300 performs an operation of the control gain for the amplitude of the driving mass resonance so that the voltage level A converges on the preset target value.

In addition, as shown in FIG. 4B, in the case in which the driving displacement signal b and a driving signal c are mixed by the mixer and are then filtered by the low pass filter (LPF), the phase value of the driving mass resonance converted into a predetermined voltage level P of the direct current (DC) form in which the high frequency components are removed may be obtained. Here, the automatic gain control unit 300 performs an operation of the control gain for the phase of the driving mass resonance so that the voltage level P converges on a ‘zero (0)’ value.

The data transmitting module 220 transmits data for the phase value or amplitude value so that the operation of the control gain for the amplitude and the phase of the driving mass resonance in the gain control module 320 is differentially performed depending to a preset ratio, where the data transmitting module may be an analog mux. A detail description thereof will be provided below.

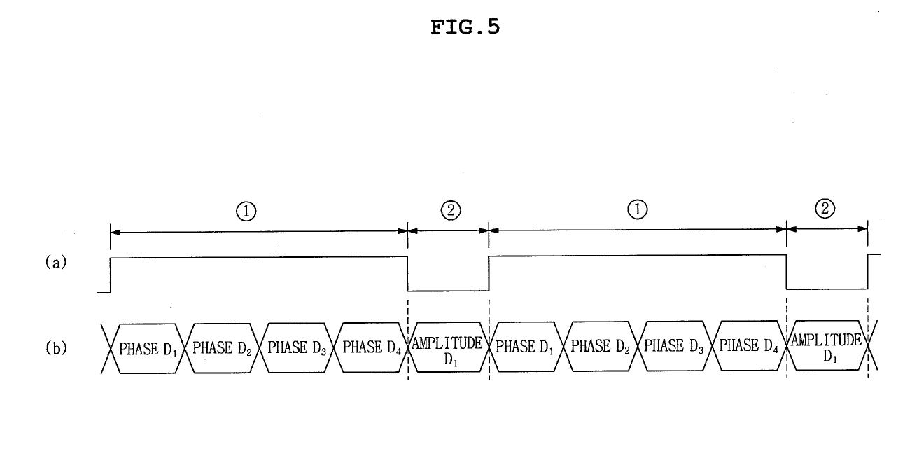

Hereinafter, a driving scheme of the automatic gain control unit according to a preferred embodiment of the present invention will be described in detail with reference to FIGS. 5A and 5B.

FIGS. 5A and 5B are diagrams showing data processing processes in an automatic gain control unit according to a preferred embodiment of the present invention, where FIG. 5A shows a data transmitting signal transmitted to the data transmitting module according to the preferred embodiment of the present invention and FIG. 5B shows an operation state of the control gain for the amplitude or phase of the driving mass resonance in the gain control module according to the preferred embodiment of the present invention.

The automatic gain control unit 300 includes the digital converting module 310, the gain control module 320, and a memory 330 and differentially performs the operation of the control gain for the amplitude or phase of the driving mass resonance depending on a preset ratio.

The digital converting module 310 converts data for the amplitude value or phase value of the driving mass resonance transmitted from the data transmitting module 220 into the digital value, where the digital converting module 310 may be an analog to digital (A/D) converter.

The gain control module 320 differentially performs the operation of the control gain for the amplitude or phase of the driving mass resonance depending on a ratio of N to 1=phase to amplitude (N≧1) so that the amplitude value or phase value of the driving mass resonance converted into the digital value converges on the preset target value, where the operation of the control gain may be performed by a proportional integral control (PID control) scheme.

That is, as shown in FIG. 5, when the gain control module 320 transmits the data transmitting signal of a high signal (“1”) and a low signal (“0”) to the data transmitting module 220 at a ratio of N to 1 in a step of performing the control gain operation (\textcircled{1}) of the phase or the control gain operation (\textcircled{2}) of the amplitude of the driving mass resonance, the data transmitting module 220 transmits the data for the amplitude value and the phase value of the driving mass resonance input from the driving circuit module 210 at the ratio of N to 1, and the gain control module 320 differentially performs the control gain operation for the phase and the amplitude of the driving mass resonance based on the transmitted data.

For example, in the case in which N is set to four (4), the gain control module 320 transmits four high signals (“1”) to the data transmitting module 220, and the data transmitting module 220 transmits four data for the phase value of the driving mass resonance, and the gain control module 320 performs the control gain operation for the phase of the driving mass resonance four times.

In addition, after the control gain operation for the phase of the driving mass resonance is performed four times, the gain control module 320 transmits one low signal (“0”) to the data transmitting module 220, the data transmitting module 220 transmits one data for the amplitude value of the driving mass resonance, and the gain control module 320 performs the control gain operation for the amplitude of the driving mass resonance once.

The memory 330 stores the pre-operated control gain for the amplitude or phase of the driving mass resonance so that the amplitude value or phase value of the driving mass resonance may approach the target value, the gain control module 320 transmit the control gain stored in the memory 330 at the time of the initial driving of the driving mass to the driving circuit module 210, and the driving circuit module 210 applies the driving signal having the control gain reflected thereto to the gyro sensor 100, thereby making it possible to drive the driving mass so as to approach the target value for the phase or amplitude of the driving mass resonance.

According to the preferred embodiment of the present invention, the size of the entire control circuit and the consumed current may be decreased and the degree of precision of the control may be increased compared to the analog scheme by controlling the phase and the amplitude of the driving mass resonance for the gyro sensor in the digital signal processing scheme using the automatic gain control unit and the A/D converter.

In addition, the gain control module differentially performs the operation of the control gain for the amplitude or the phase of the driving mass resonance at the ratio of N to 1 (phase to amplitude), such that the operation of the control gain for the phase of the driving mass resonance is performed so that the phase difference between the driving signal and the driving displacement signal approaches 90° and the operation of the control gain for the amplitude of the driving mass resonance is then performed so as to converge on the target value, thereby making it possible to more rapidly control the driving mass so as to stably be resonated.

In addition, the pre-operated control gain for the amplitude or phase of the driving mass resonance is stored in the memory so that the amplitude value or phase value of the driving mass resonance may approach the preset target value to thereby use the control gain as the initial value at the time of the driving of the driving mass, such that the control for the amplitude or phase of the driving mass resonance may be performed in the range adjacent to the target value from the initial driving, thereby making it possible to secure reliability and efficiency for the output signal of the gyro sensor.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus for driving a gyro sensor, the apparatus comprising:
a driving unit detecting an amplitude value and a phase value of a driving mass resonance from a driving displacement signal of a gyro sensor and transmitting data for the phase value or amplitude value;
an automatic gain control unit differentially performing an operation of a control gain for an amplitude or phase of the driving mass resonance depending on a preset ratio so that after converting the phase value or amplitude value transmitted from the driving unit into a digital value, the digital value converges on a preset target value; and
a first signal converting unit converting the control gain into an analog value and transmitting the analog value to the driving unit.

2. The apparatus for driving the gyro sensor as set forth in claim 1, wherein the driving unit transmits data for the phase value or amplitude value so that the operation of the control gain for the amplitude or phase of the driving mass resonance of the automatic gain control unit is performed depending on the preset ratio.

3. The apparatus for driving the gyro sensor as set forth in claim 1, wherein the automatic gain control unit allows the operation of the control gain for the phase and the amplitude of the driving mass resonance to be differentially performed depending on a ratio of N to 1=phase to amplitude (N≧1).

4. The apparatus for driving the gyro sensor as set forth in claim 1, wherein the automatic gain control unit applies a pre-operated control gain for the amplitude or phase of the driving mass resonance to the driving mass so that the amplitude value or phase value of the driving mass resonance approaches the target value at the time of an initial driving of the driving mass.

5. The apparatus for driving the gyro sensor as set forth in claim 1, wherein the first signal converting unit is a digital to analog (D/A) converter.

6. The apparatus for driving the gyro sensor as set forth in claim 1, wherein the driving unit includes:
a driving circuit module generating a driving signal having the control gain for the phase or amplitude of the driving mass resonance reflected thereto to thereby apply the driving signal to the gyro sensor and receiving a driving displacement signal from the gyro sensor to thereby detect the phase value and the amplitude value of the driving mass resonance; and
a data transmitting module transmitting data for the phase value or amplitude value so that the operation of the control gain for the amplitude or phase of the driving mass resonance in the automatic gain control unit is differentially performed depending on the preset ratio.

7. The apparatus for driving the gyro sensor as set forth in claim 6, wherein the driving circuit module mixes the driving displacement signal with a signal having a phase retarded by 90° compared to the driving signal to thereby detect the amplitude value of the driving mass resonance; and mixes the driving displacement signal with a signal having the same phase as the driving signal to thereby detect the phase value of the driving mass resonance.

8. The apparatus for driving the gyro sensor as set forth in claim 6, wherein the data transmitting module is an analog mux.

9. The apparatus for driving the gyro sensor as set forth in claim 1, wherein the automatic gain control unit includes:
a digital converting module converting the amplitude value or phase value of the driving mass resonance input from the driving unit into a digital value; and
a gain control module differentially performing the operation of the control gain for the amplitude and the phase of the driving mass resonance depending to a ratio of N to 1 (N≧1) so that the digital value converges on the preset target value.

10. The apparatus for driving the gyro sensor as set forth in claim 9, wherein the automatic gain control unit includes a memory storing the pre-operated control gain for the amplitude or phase of the driving mass resonance so that the amplitude value or phase value of the driving mass resonance approaches the target value at the time of an initial driving of the driving mass.

11. A method for controlling an apparatus for driving a gyro sensor, the method comprising:
detecting, by a driving unit, an amplitude value and a phase value of a driving mass resonance from a driving displacement signal of a gyro sensor;
transmitting, by the driving unit, data of the amplitude value or phase value of the driving mass resonance;
differentially performing, by an automatic gain control unit, an operation of a control gain for an amplitude or phase of the driving mass resonance depending on a preset ratio so that after converting data for the amplitude value or phase value into a digital value, the digital value converges on a preset target value; and
converting, by a first signal converting unit, the control gain into an analog value and transmitting the analog value to the driving unit.

12. The method as set forth in claim 11, further comprising, before the detecting of the amplitude value and the phase value of the driving mass resonance,
receiving the pre-operated control gain for the amplitude or phase of the driving mass resonance from the automatic gain control unit so that the amplitude value or phase value of the driving mass resonance stored in a memory approaches the target value, at the time of an initial driving of a driving mass; and
applying a driving signal having the control gain reflected thereto to the gyro sensor.

13. The method as set forth in claim 11, wherein the detecting of the amplitude value and the phase value of the driving mass resonance includes:
applying a driving signal having the control gain reflected thereto to the gyro sensor and receiving the driving displacement signal from the gyro sensor;
mixing the driving displacement signal with a signal having a phase retarded by 90° compared to the driving signal to thereby detect the amplitude value of the driving mass resonance; and
mixing the driving displacement signal with a signal having the same phase as the driving signal to thereby detect the phase value of the driving mass resonance.

14. The method as set forth in claim 11, wherein the transmitting of the data of the amplitude value or phase value of the driving mass resonance includes:
transmitting, by the automatic gain control unit, a data transmitting signal to the driving unit so that the operation of the control gain for the phase and the amplitude of the driving mass resonance is differentially performed depending on a ratio of N to 1; and
transmitting, by the driving unit, data for the phase value or amplitude value of the driving mass resonance depending on the data transmitting signal.

15. The method as set forth in claim 11, wherein the differentially performing, by the automatic gain control unit, of the operation of the control gain for the amplitude or phase of the driving mass resonance depending on the preset ratio includes:
converting, by a digital converting module, the amplitude value or phase value of the driving mass resonance input from the driving unit into a digital value; and
differentially performing, a gain control module, the operation of the control gain for the phase and the amplitude of the driving mass resonance depending on a ratio of N to 1 (N≧1) so that the digital value converges on the preset target value.

16. The method as set forth in claim 15, wherein the digital converting module is an analog to digital (A/D) converter.

17. The method as set forth in claim 11, wherein the first signal converting unit is a digital to analog (D/A) converter.
